(19) United States
(12) Patent Application Publication
(10) Pub. No.: US 2017/0337055 A1
(43) Pub. Date: Nov. 23, 2017

(54) SUMMARIZED ILLUSTRATIVE REPRESENTATION OF SOFTWARE CHANGES

(71) Applicant: International Business Machines Corporation, Armonk, NY (US)

(72) Inventors: Deborah H. Bandera, Austin, TX (US); Sara C. Brumfield, Austin, TX (US); Paula Springstead, Round Rock, TX (US)

(21) Appl. No.: 15/161,779

(22) Filed: May 23, 2016

(51) Int. Cl. G06F 9/44

(52) U.S. Cl. CPC G06F 8/73

(57) ABSTRACT

An approach, for creating summarized illustrative representation of software changes. A change summary illustrator, receives a software product change identifier and associated components. The change summary illustrator, identifies at least one of change information associated with at least one of the associated components. The change summary illustrator, determines, at least one of the change information to include at least one of change size attributes and pervasiveness attributes. The change summary illustrator, creates at least one of change size magnitudes and pervasiveness magnitudes, based on categorization of the change size attributes and the pervasiveness attributes, respectively. The change summary illustrator, generates illustrative representations associated with at least one of the associated components including at least one of the change size magnitudes and the pervasiveness magnitudes and outputs the illustrative representations associated with the software product change identifier.

### BACKGROUND OF THE INVENTION

The present invention relates generally to software product change tracking and more particularly, to illustrating identified software changes in a release package to assist installation decision making.

When defect fixes, performance improvements, usability and feature enhancements are provided in a software product, the components of changes can be listed in a package for release to users/customers. A software product update list can be known by names such as, but not limited to, fix pack, service pack, product update, Authorized Program Analysis Report (APAR) list and patch list. Each software change in a package can list attributes such as, but not limited to, change identifier, component (e.g., area, function affected), component description, symptom of a defect/feature, solution/feature comprised in software release, affected product version(s) and affected user type/scope. When changes are released, the components of a software release package can comprise function that may not affect a specific user installation and a user can make a determination on whether or not to install the software release. For a user to make a determination on if a software product change is a candidate for installation, each affected component in a release can be researched individually by analyzing associated documentation.

As each software product update is released, analysis of components in a change list can become cumbersome to analyze and can cause users to disregard a range of available updates until usability problems are identified by end-users. Conversely, users may avoid change analysis and install each available update where some updates may comprise unused logic for a customer installation and can adversely affect business operations by causing unnecessary testing and system deployment down-time.

### SUMMARY

As disclosed herein, a method for creating summarized illustrative representation of software changes, the method comprising: receiving, by change summary illustrator, a software product change identifier and one or more associated component identifiers; identifying, by the change summary illustrator, at least one of one or more change information associated with at least one of the one or more associated component identifiers; determining, by the change summary illustrator, one or more change size attributes and one or more pervasiveness attributes associated with the one or more change information; creating, by the change summary illustrator, one or more change size magnitudes and one or more pervasiveness magnitudes, wherein the one or more change size attributes and the one or more pervasiveness attributes, are categorized and summarized, respectively; generating, by the change summary illustrator, one or more illustrative representations associated with the one or more associated component identifiers comprising the one or more change size magnitudes and the one or more pervasiveness magnitudes and outputting, by the change summary illustrator, the one or more illustrative representations associated with the software product change identifier. A computer system and a computer program product corresponding to the above method are also disclosed herein.

### BRIEF DESCRIPTION OF THE DRAWINGS

FIG. 1 is a functional block diagram illustrating a computing environment, in accordance with an embodiment of the present invention;

FIG. 2 depicts a flowchart of software change content illustration processing, in accordance with an embodiment of the present invention;

FIG. 3A depicts sample component change summary illustration results data, in accordance with an embodiment of the present invention;

FIG. 3B depicts sample illustrative output of a software change package, in accordance with an embodiment of the present invention; and

FIG. 4 depicts a block diagram of components of the server and/or the computing device, in accordance with an embodiment of the present invention.

### DETAILED DESCRIPTION

Embodiments of the present invention analyze, summarize and illustrate changed components in a software release where the summary changes can be represented by size of component change and/or pervasiveness of each component change. Embodiments of the present invention provide an improved approach for graphically representing the contents of software package changes (e.g., fix packs, service packs and APARs) to provide an “at-a-glance” view of extensiveness and pervasiveness of software fixes. How much code has been changed (e.g., extensiveness) and how important the fixes are (e.g., pervasiveness of the issues) can reduce the research and assessment time for administrators to determine if a software change package should be installed. Size of component change can be expressed in terms such as, but not limited to, number of lines of code affected, size of function(s)/module(s) changed and byte count of function(s)/module(s). Pervasiveness of each component change can be defined by factors such as, but not limited to, level of function (e.g., main function vs. subroutine), function dependency (e.g., calls to and/or from other functions associated to a changed function, number of reported problems associated to a changed component, number of customers reporting component problem and/or requesting component change. A summarized illustrative output of a software release can comprise component change size and/or change pervasiveness for presentation in a variety of formats such as, but not limited to, bubble chart, word cloud, histogram and sorted list to create an ‘at-a-glance’ view for a user to determine if the software release comprises changes of interest.

Embodiments of the present invention will now be described in detail with reference to the figures. It should be noted that references in the specification to “an exemplary embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure or characteristic is described in connection with an embodiment, it is submitted that it is within the knowledge of one skilled in the art to affect such feature, structure or characteristic in connection with other embodiments whether or not explicitly described.

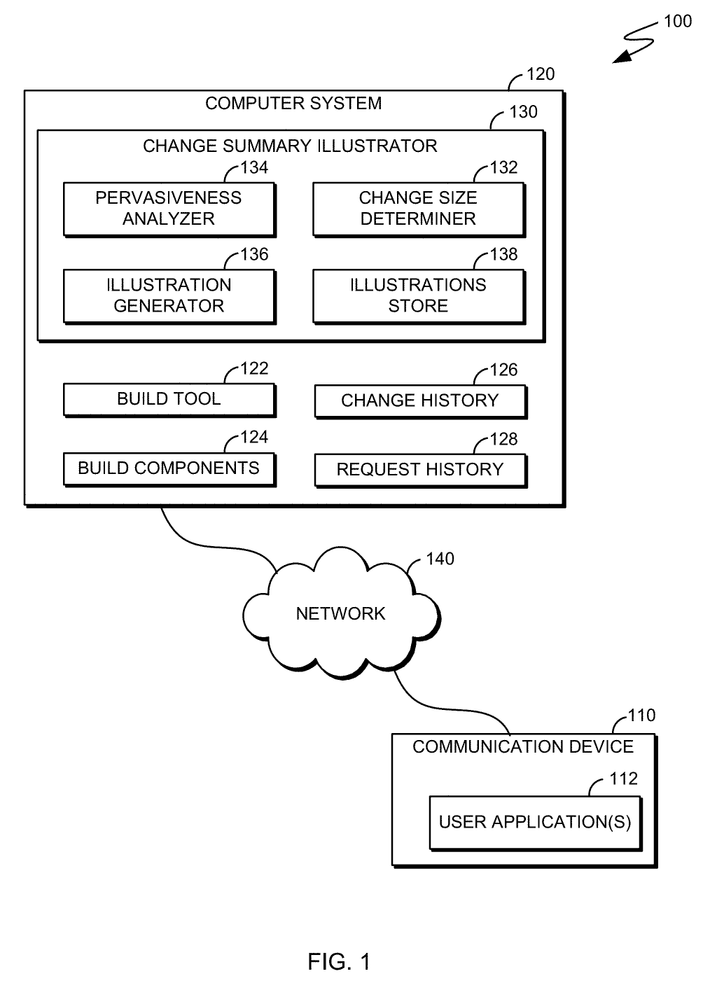

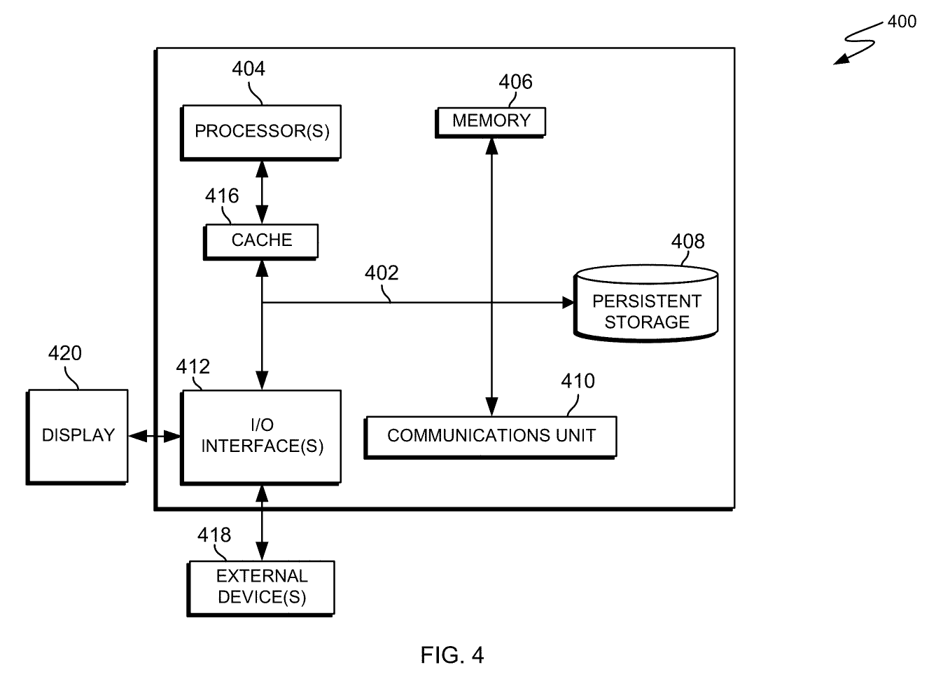

FIG. 1 is a functional block diagram of computing environment 100, in accordance with an embodiment of the present invention. Computing environment 100 comprises COMMUNICATION DEVICE 110 and COMPUTER SYSTEM 120, interconnected via NETWORK 140. COMMUNICATION DEVICE 110 and COMPUTER SYSTEM 120 can be desktop computers, laptop computers, specialized computer servers, or the like. In certain embodiments, COMMUNICATION DEVICE 110 and COMPUTER SYSTEM 120 represent computer systems utilizing clustered computers and components acting as a single pool of seamless resources via NETWORK 140. For example, such embodiments can be used in data center, cloud computing, storage area network (SAN), and network attached storage (NAS) applications. In general, COMMUNICATION DEVICE 110 and COMPUTER SYSTEM 120 are representative of any electronic devices, or combination of electronic devices, capable of executing computer readable program instructions, as described in detail with regard to FIG. 4.

NETWORK 140 can be, for example, a local area network (LAN), a wide area network (WAN) such as, the Internet, or a combination of the two, and include wired, wireless, or fiber optic connections. In general, NETWORK 140 can be any combination of connections and protocols that can support communications between COMMUNICATION DEVICE 110 and COMPUTER SYSTEM 120, in accordance with an embodiment of the present invention.

In one embodiment of the present invention, COMPUTER SYSTEM 120 comprises, BUILD TOOL 122, BUILD COMPONENTS 124, CHANGE HISTORY 126, REQUEST HISTORY 128 and CHANGE SUMMARY ILLUSTRATOR 130.

In one embodiment of the present invention, BUILD TOOL 122 can be a plurality of BUILD TOOLS 122 within COMPUTER SYSTEM 120. BUILD TOOL 122 can comprise any combination of commercial or custom devices and/or software products with capabilities perform functions such as, but not limited to, package software components into identifiable releases, compile source code, execute test scripts and analyze code coverage. Further, BUILD TOOL 122 can send information toward and/or operate CHANGE SUMMARY ILLUSTRATOR 130. As BUILD TOOL 122 operates, information can be received and processed from BUILD COMPONENTS 124, CHANGE HISTORY 126 and REQUEST HISTORY 128 to identify and/or validate software components comprising a software release package.

In one embodiment of the present invention, BUILD COMPONENTS 124 can be a plurality of BUILD COMPONENTS 124 within COMPUTER SYSTEM 120. BUILD COMPONENTS 124 can be a data store comprising information such as, but not limited to, source code, program modules and associated component identification used to package changed software components in a software release.

In one embodiment of the present invention, CHANGE HISTORY 126 can be a plurality of CHANGE HISTORIES 126 within COMPUTER SYSTEM 120. CHANGE HISTORY 126 can be a data store based on software component change documentation comprising information such as, but not limited to, program component ID, component description, reported problem, problem symptom, problem solution and affected components. Further, change documentation sources can comprise software product documentation artifacts such as, but not limited to, APAR, Fix Pack, Patch and release notes.

In one embodiment of the present invention, REQUEST HISTORY 128 can be a plurality of REQUEST HISTORIES 128 within COMPUTER SYSTEM 120. REQUEST HISTORY 128 can be a data store comprising data such as, but not limited to, change request, reported problem, symptoms, solutions, meta data associated to CHANGE HISTORY 126 data and metadata associated to BUILD COMPONENTS 124.

In one embodiment of the present invention, CHANGE SUMMARY ILLUSTRATOR 130 can comprise, CHANGE SIZE DETERMINER 132, PERVASIVENESS ANALYZER 134, ILLUSTRATION GENERATOR 136 and ILLUSTRATIONS STORE 138. CHANGE SUMMARY ILLUSTRATOR 130 can be a plurality of CHANGE SUMMARY ILLUSTRATORS 130 within COMPUTER SYSTEM 120 and CHANGE SUMMARY ILLUSTRATOR 130 can be a separate and/or integrated tool that can be operated during software build (e.g., BUILD TOOL 122) and/or with software release package documentation to determine and/or output change summary illustrations.

In one embodiment of the present invention, CHANGE SIZE DETERMINER 132 can be a plurality of CHANGE SIZE DETERMINERS 132 within CHANGE SUMMARY ILLUSTRATOR 130. CHANGE SIZE DETERMINER 132 can receive information from BUILD COMPONENTS 124 and/or CHANGE HISTORY 126. Change size can be measured by factors such as, but not limited to, lines of code and bytes of code based on each component comprising a sofware release. Further, size of lines of code can range from an actual count of line changed, number of code lines (changed and unchanged) in a module/function where a change exists and count of lines of code compising a changed module and associated dependent modules. CHANGE SIZE DETERMINER 132 can calculate change size and/or create categorized counts/size based on matching relative magnitude terms such as, but not limited to, tiny, small, medium, large and extra-large based on predetermined threshold range categorization rules. When CHANGE SIZE DETERMINER 132 completes processing, change size of components in a software release can be sent toward ILLUSTRATION GENERATOR 136.

In one embodiment of the present invention, PERVASIVENESS ANALYZER 134 can be a plurality of PERVASIVENESS ANALYZERS 134 within CHANGE SUMMARY ILLUSTRATOR 130. PERVASIVENESS ANALYZER 134 can receive information from BUILD COMPONENTS 124, REQUEST HISTORY 128 and/or CHANGE HISTORY 126. Pervasiveness of a change can be measured by factors such as, but not limited to, modules changed, module usage (e.g., main routine, high usage vs. subroutine, low usage), number of calls to/from a module (e.g., routine dependancies), number of problems reported for affected components and number of users/customers affected by change. Further, PERVASIVENESS ANALYZER 134 can calculate pervasiveness measures (e.g., module usage, number of requests for a change) and/or create categorized pervasiveness values based on the pervasiveness measures matching relative magnitude terms such as, but not limited to, all, large, medium, small and customer/installation unique. For example, pervasiveness categories can be predetermined by threshold ranges such as, but not limited to, percentage of clients (e.g., customers) that can be affected by a component change. Example pervasiveness magnitude values can comprise all as 100% of clients, large as 75%-99% of clients, medium as 50-75% of clients, small as 20-50% of clients and customer/installation unique as less than 20% of clients and/or by identified customer. When PERVASIVENESS ANALYZER 134 completes processing, change pervasiveness information of the components in a software release can be sent toward ILLUSTRATION GENERATOR 136.

In one embodiment of the present invention, ILLUSTRATION GENERATOR 136 can be a plurality of ILLUSTRATION GENERATORS 136 within CHANGE SUMMARY ILLUSTRATOR 130. ILLUSTRATION GENERATOR 136 can receive software release component information from CHANGE SIZE DETERMINER 132 and/or PERVASIVENESS ANALYZER 134 to generate data for illustrative presentation of software release changes based on component change size and/or component change pervasiveness. When ILLUSTRATION GENERATOR 136 completes generation of an illustrative representation comprising a software release, the resulting data can be output toward ILLUSTRATIONS STORE 138 for presentation. It should be noted that one or more categorizations can represent change pervasivenes and change size which can enable fixed/static illustration output. Multiple change size and/or pervasiveness measures can enable dynamic presentation of illustration attributes based on user selectable controls during output toward USER APPLICATION(S) 112.

In one embodiment of the present invention, ILLUSTRATIONS STORE 138 can be a plurality of ILLUSTRATIONS STORES 138 within CHANGE SUMMARY ILLUSTRATOR 130. It should be noted that embodiments of the present invention can comprise ILLUSTRATIONS STORES 138 in CHANGE SUMMARY ILLUSTRATOR 130, COMMUNICATION DEVICE 110 and/or COMPUTER SYSTEM 120 for access by USER APPLICATION(S) 112. ILLUSTRATIONS STORE 138 can be a data store used to present illustrations of a changed components of software releases.

In one embodiment of the present invention, COMMUNICATION DEVICE 110 comprises USER APPLICATION(S) 112.

In one embodiment of the present invention, USER APPLICATION(S) 112 can be a plurality of USER APPLICATION(S) 112 within COMMUNICATION DEVICE 110. USER APPLICATION(S) 112 can comprise any combination of commercial or custom devices and/or software products comprising capabilities such as, but not limited to, viewing and interacting with illustrative output of CHANGE SUMMARY ILLUSTRATOR 130 and/or received from ILLUSTRATIONS STORE 138.

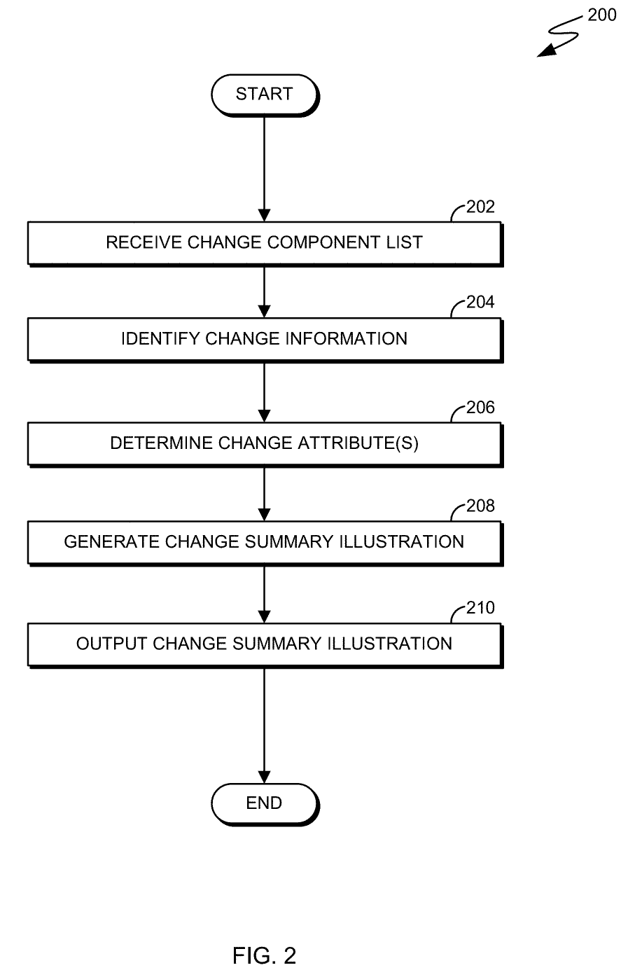

FIG. 2 depicts a flowchart of software change content illustration processing, in accordance with an embodiment of the present invention. Change summary illustrator 200 comprises operations RECEIVE CHANGE COMPONENT LIST 202, IDENTIFY CHANGE INFORMATION 204, DETERMINE CHANGE ATTRIBUTE(S) 206, GENERATE CHANGE SUMMARY ILLUSTRATION 208 and OUTPUT CHANGE SUMMARY ILLUSTRATION 210.

Operation RECEIVE CHANGE COMPONENT LIST 202 can receive BUILD TOOL 122 data that can identify a list of components comprising a software release. It should be noted that identification of a software release and associated components can be in any format recognized by CHANGE SUMMARY ILLUSTRATOR 130.

Operation IDENTIFY CHANGE INFORMATION 204 can search data sources such as, but not limited to, BUILD COMPONENTS 124, CHANGE HISTORY 126 and REQUEST HISTORY 128 for change information. Based on each change component identified in a software release, operation IDENTIFY CHANGE INFORMATION 204 can tag associated information such as, but not limited to, changed lines of code, change sources (e.g., problem id, request id), resolution sources (e.g., installation notes, programmer notes), customer(s) associations and functional area(s) of change. It should be noted that identification of fixes and/or enhancements can be tagged by methods such as, but not limited to, marking original data stores and relationally referencing sources in ILLUSTRATIONS STORE 138. Sources such as, but not limited to, BUILD TOOL 122 artifacts, programming release notes, enhancement, problem and resolution (e.g., CHANGE HISTORY 126, REQUEST HISTORY 128) can be searched and tagged to determine size and pervasiveness of component changes for a software release.

Operation DETERMINE CHANGE ATTRIBUTE(S) 206 can determine change attributes identified by operation IDENTIFY CHANGE INFORMATION 204. Change attributes can be categorized as size and/or pervasiveness related to each changed component. Size and/or pervasiveness attributes can be summarized by count and/or numeric summation and further grouped into relative magnitude terms such as, but not limited to, small, medium, large and extra-large. Change attributes used to indicate size and/or pervasiveness associated to components in a software release can be documented by methods such as, but not limited to, by a Programmer as part of a software release build, querying metadata artifacts created during a software release build and by querying object such as, but not limited to, problem ticket and enhancement requests.

Operation GENERATE CHANGE SUMMARY ILLUSTRATION 208 can collect and summarize component change attributes received from operation DETERMINE CHANGE ATTRIBUTE(S) 206. Component identifiers comprising a software release can be used to group and record attributes of a change summary illustration. In one embodiment of the present invention, illustration information can be sent toward ILLUSTRATIONS STORE 138 for graphical and/or textual summary output. In other embodiments of the present invention, operation GENERATE CHANGE SUMMARY ILLUSTRATION 208 can dynamically generate illustration information based on predetermined parameters and/or user interaction.

Operation OUTPUT CHANGE SUMMARY ILLUSTRATION 210, can create an output file based on received data from operation GENERATE CHANGE SUMMARY ILLUSTRATION 208 and/or ILLUSTRATIONS STORE 138. Output can comprise formats such as, but not limited to, graphic image, word cloud, text report, Extensible Markup Language (XML) and other data formats capable of presentation and/or operation with USER APPLICATION(S) 112.

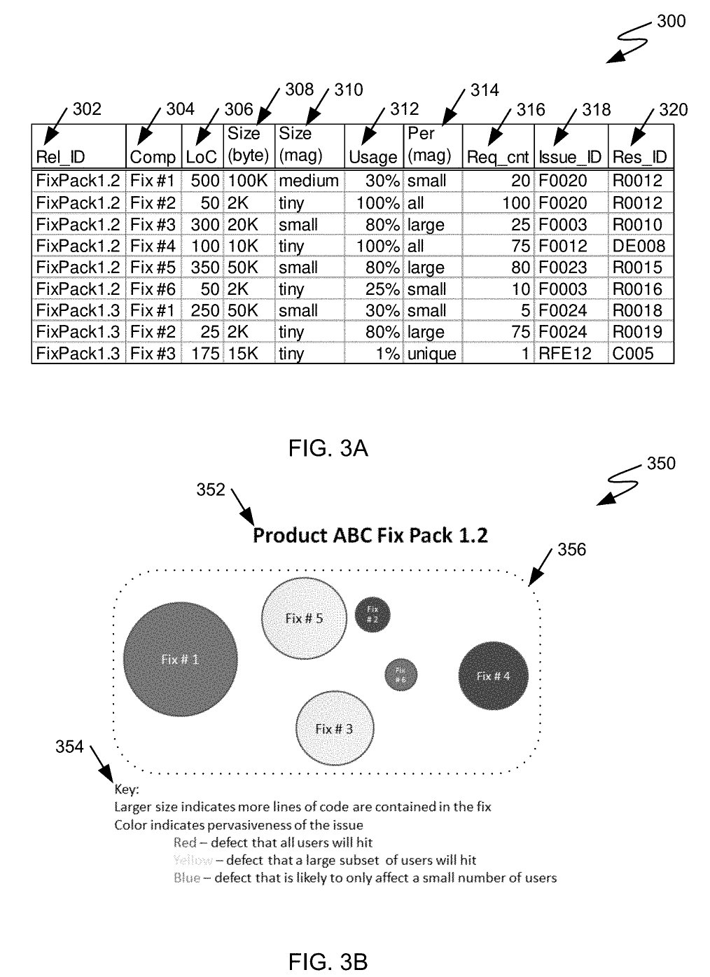

FIG. 3A depicts sample component change summary illustration result data, in accordance with an embodiment of the present invention. It should be noted that illustration results data 300 depicts sample data that can be stored in ILLUSTRATIONS STORE 138 and is presented in tabular form to assist describing CHANGE SUMMARY ILLUSTRATOR 130. It should be noted that storage format, technology and data content of CHANGE SUMMARY ILLUSTRATOR 130 can vary based on size and pervasiveness metrics being implemented. Illustration result data 300, comprise items Rel_ID 302, Comp 304, LoC 306, Size (byte) 308, Size (mag) 310, Usage 312, Per (mag) 314, Req_cnt 316, Issue_ID 318 and Res_ID 320.

Item Rel_ID 302 can be an identifier of a software release created during build process executed by BUILD TOOL 122. In the example table, two illustrations are identified as FixPack1.2 and FixPack1.3

Item Comp 304 can be an identifier of a software component comprising a software release and can be the identifier associated to size of change and/or pervasiveness of change in a software release.

Item LoC 306 ‘Lines of Code’, item Size (byte) 308 ‘Code Module Size’ and item Size (mag) 310 ‘magnitude of code size’ can be different units of measure of code change size as determined by CHANGE SIZE DETERMINER 132. Item LoC 306 and item Size (byte) 308 are examples of size of change associated to a component (e.g., item Comp 304). Item Size (mag) 310 depicts at-a-glance relative magnitude assignments that can be used in graphical representations of component change size in a software release.

Item Usage 312 and item Per (mag) 314 are example measures of pervasiveness associated to component change in a software release. Item Usage 312 can be a result received from PERVASIVENESS ANALYZER 134 and in this example can represent the probable number of clients that can be affected by the associated component change. For example, item Usage 312 value of 100% can indicate a main function/module was changed and all users will execute the function where 80% can indicate that a component comprises a typical function used by a large number of users (e.g., a print function can be frequently used). Item Per (mag) 314 can be a magnitude measure of pervasiveness identified by item Usage 312 where a range of usage values are categorized for at-a-glance graphical representation.

Item Req_cnt 316, request count can be a summation of reported incidents such as, but not limited to, bug reports, enhancements and feature proposals. Item Req_cnt 316 can be an example of a variety of a pervasiveness measure where popularity of enhancement and/or demand for a bug fix can be detailed and/or assigned magnitudes (not depicted) for use in graphical illustrations.

Item Issue_ID 318, Issue identifier and item Res_ID 320, resolution identifier can be referential pointers toward software release build history and/or support documentation. Item Issue_ID 318 can comprise associated issues and/or change requests stored in CHANGE HISTORY 126 and/or REQUEST HISTORY 128. Item Res_ID 320 can comprise associated issues and/or change requests resolutions stored in CHANGE HISTORY 126 and/or REQUEST HISTORY 128. It should be noted that item Issue_ID 318 values can appear duplicate as an identified issue can be attributed to one or more affected components in a software release. Further, item Res_ID 320 values can appear duplicate as a resolution can solve one or more issues and/or affect one or more components in a software release. Item Issue_ID 318 and item Res_ID 320 columns can have for a range of uses such as, but not limited to, enabling drill-down and hyperlinks toward supporting detail associated to a change summary illustration. For example, item Issue_ID 318 values appear with prefix ‘F’ to indicate a fix, however value ‘RFE12’ can indicate a customer ‘Request For Enhancement’ was resolved for customer ‘C005’ (e.g., item Res_ID 320). In this example, associated item Usage 312 value ‘1%’, item Per (mag) 314 value ‘unique’ and item Req_cnt 316 value ‘1’ can indicate a single customer is affected by a component change which can influence software release installation decision making. It should be noted that, item Res_ID 320 can indicate a range of resolution sources. For example, item Res_ID 320 value ‘DE008’ can indicate that Development Engineering could have initiated and resolved item Issue_ID 318 ‘F0012’. In this example, graphic illustrations can provide dynamic output based on an identity such as, but not limited to, user type, customer and change source.

FIG. 3B depicts sample illustrative output of a software change package, in accordance with an embodiment of the present invention. Fix pack graphic 350 comprises items SOFTWARE RELEASE IDENTIFIER 352, ILLUSTRATION KEY 354 and CHANGE ILLUSTRATION 356. It should be noted that fix pack graphic 350 partially depicts Item Rel_ID 302, ‘FixPack1.2’ as identified in FIG. 3A.

Item SOFTWARE RELEASE IDENTIFIER 352 can display the software release that the illustration represents. In this example, Fix Pack 1.2 for Product ABC is represented.

Item ILLUSTRATION KEY 354 can provide informational cues to assist interpretation of item CHANGE ILLUSTRATION 356.

Item CHANGE ILLUSTRATION 356 depicts components of Product ABC Fix Pack 1.2 identified as Fix #1-6. In FIG. 3B, Fix #1 is presented as a larger object as compared to other Fix #2-6 and can indicate that the most changed lines of code were affected in Fix #1 while Fix #1 is color coded as ‘Blue’ which indicates that pervasiveness affects ‘a small number of users’. While Fix #4 appears smaller in size as compared to Fix #1 and Fix #5, Fix #4 is colored ‘Red’ which can indicate ‘all’ users are affected. FIG. 3B can influence, at-a-glance, a decision and/or a need to investigate Product ABC Fix Pack 1.2 as an installation candidate. For example, an observation of Fix #1 as the largest changed component can be compared to Fix #2 through Fix #5 to suggest the combination of Fix #2 through Fix #5 components as larger and more pervasive than Fix #1 and Fix #6. The prior observation may justify installation of the software release to avoid risk of deferring and/or avoiding the software release. It should be noted that color coding can be implemented using shading and/or other method to highlight differences among components in a software release. It should be noted further that change size and change pervasiveness can interchange where pervasiveness could be represented as object size and change size could be represented by color. In some embodiments of the present invention, one or more of the components (e.g., Fix #1 through Fix #6) can provide link(s) (e.g., hyperlink) to present detailed information comprising each component. Detailed information can provide data such as, but not limited to, release notes, change abstracts, installation instructions, customers affected and component related change history. Still further, embodiments of the present invention can provide dynamic selection of different pervasiveness criteria as describe in FIG. 3A. In a dynamic illustration mode, a user could interact with FIG. 3B illustration to re-draw the components in context of attributes stored in ILLUSTRATIONS STORE 138. For example, an interactive selection could switch pervasiveness output based on item Per (mag) 314 (e.g., small, large, all) to actual request counts (e.g., item Req_cnt 316). In this form, a larger count could indicate that a component comprises a ‘high demand’ enhancement request. Further, an identified customer ‘C005’ (e.g., item Res_ID 320) could dynamically highlight components comprising ‘unique’ pervasiveness (e.g., item Per (mag) 314).

FIG. 4 depicts a block diagram of components of COMMUNICATION DEVICE 110 and COMPUTER SYSTEM 120 in accordance with an illustrative embodiment of the present invention. It should be appreciated that FIG. 4 provides an illustration of one implementation and does not imply any limitations with regard to the environments in which different embodiments may be implemented. Many modifications to the depicted environment may be made.

Computer system 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as, microprocessors, communications and network processors, etc.), system memory, peripheral devices, and any other hardware components within a system. For example, communications fabric 402 can be implemented with one or more buses.

Computer system 400 includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as, microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external devices 418 such as, a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as, punch-cards or raised structures in a groove having instructions recorded thereon, and any suitable combination of the foregoing. A computer readable storage medium, as used herein, is not to be construed as being transitory signals per se, such as, radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as, Smalltalk, C++ or the like, and conventional procedural programming languages, such as, the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for creating summarized illustrative representation of software changes, the method comprising:
receiving, by change summary illustrator, a software product change identifier and one or more associated component identifiers;
identifying, by the change summary illustrator, at least one of one or more change information associated with at least one of the one or more associated component identifiers;
determining, by the change summary illustrator, one or more change size attributes and one or more pervasiveness attributes associated with the one or more change information;
creating, by the change summary illustrator, one or more change size magnitudes and one or more pervasiveness magnitudes, wherein the one or more change size attributes and the one or more pervasiveness attributes, are categorized and summarized, respectively;
generating, by the change summary illustrator, one or more illustrative representations associated with the one or more associated component identifiers comprising the one or more change size magnitudes and the one or more pervasiveness magnitudes; and
outputting, by the change summary illustrator, the one or more illustrative representations associated with the software product change identifier.

2. The method of claim 1, wherein determining, by the change summary illustrator, the one or more change information is based on tagging at least one of the one or more change size attributes and the one or more pervasiveness attributes based on at least one of one or more predetermined change size attributes and one or more predetermined pervasiveness attributes, respectively.

3. The method of claim 1, wherein creating, by the change summary illustrator, the one or more change size magnitudes is based on the one or more change size attributes matching one of a one or more predetermined threshold value range associated with predetermined one or more change size magnitude categories comprising identifiers of tiny, small, medium, large and extra-large.

4. The method of claim 1, wherein creating, by the change summary illustrator, the one or more pervasiveness magnitudes is based on the one or more pervasiveness attributes matching one of a one or more predetermined threshold value range associated with predetermined one or more pervasiveness magnitude categories comprising identifiers of small, medium, large and customer unique.

5. The method of claim 1, wherein generating, by the change summary illustrator, the one or more illustrative representations further comprises at least one of one or more selectable component change size criteria and one or more selectable pervasiveness criteria.

6. The method of claim 1, wherein the one or more associated component identifiers is based on one or more change documentation sources wherein the one or more change documentation sources comprise at least one of a fix pack, a service pack, Authorized Program Analysis Report, patch notes, release notes and source code.

7. The method of claim 1, wherein the one or more illustrative representations comprise at least one of one or more graphical illustration user presentation, one or more stored illustrative representations and one or more illustrative representations data.

8. A computer program product for creating summarized illustrative representation of software changes, the computer program product comprising:
one or more computer readable storage media and program instructions stored on the one or more computer readable storage media, the program instructions comprising:
program instructions to, receive, by change summary illustrator, a software product change identifier and one or more associated component identifiers;
program instructions to, identify, by the change summary illustrator, at least one of one or more change information associated with at least one of the one or more associated component identifiers;
program instructions to, determine, by the change summary illustrator, one or more change size attributes and one or more pervasiveness attributes associated with the one or more change information;
program instructions to, create, by the change summary illustrator, one or more change size magnitudes and one or more pervasiveness magnitudes, wherein the one or more change size attributes and the one or more pervasiveness attributes, are categorized and summarized, respectively;
program instructions to, create, by the change summary illustrator, one or more illustrative representations associated with the one or more associated component identifiers comprising the one or more change size magnitudes and the one or more pervasiveness magnitudes; and
program instructions to, output, by the change summary illustrator, the one or more illustrative representations associated with the software product change identifier.

9. The computer program product of claim 8, wherein determine, by the change summary illustrator, the one or more change information is based on tagging at least one of the one or more change size attributes and the one or more pervasiveness attributes based on at least one of one or more predetermined change size attributes and one or more predetermined pervasiveness attributes, respectively.

10. The computer program product of claim 8, wherein create, by the change summary illustrator, the one or more change size magnitudes is based on the one or more change size attributes matching one of a one or more predetermined threshold value range associated with predetermined one or more change size magnitude categories comprising identifiers of tiny, small, medium, large and extra-large.

11. The computer program product of claim 8, wherein create, by the change summary illustrator, the one or more pervasiveness magnitudes is based on the one or more pervasiveness attributes matching one of a one or more predetermined threshold value range associated with predetermined one or more pervasiveness magnitude categories comprising identifiers of small, medium, large and customer unique.

12. The computer program product of claim 8, wherein generate, by the change summary illustrator, the one or more illustrative representations further comprises at least one of one or more selectable component change size criteria and one or more selectable pervasiveness criteria.

13. The computer program product of claim 8, wherein the one or more associated component identifiers is based on one or more change documentation sources wherein the one or more change documentation sources comprise at least one of a fix pack, a service pack, Authorized Program Analysis Report, patch notes, release notes and source code.

14. The computer program product of claim 8, wherein the one or more illustrative representations comprise at least one of one or more graphical illustration user presentation, one or more stored illustrative representations and one or more illustrative representations data.

15. A computer system for creating summarized illustrative representation of software changes, the computer system comprising:
one or more computer processors;
one or more computer readable storage media;
program instructions stored on the one or more computer readable storage media for execution by at least one of the one or more computer processors, the program instructions comprising:
program instructions to, receive, by change summary illustrator, a software product change identifier and one or more associated component identifiers;
program instructions to, identify, by the change summary illustrator, at least one of one or more change information associated with at least one of the one or more associated component identifiers;
program instructions to, determine, by the change summary illustrator, one or more change size attributes and one or more pervasiveness attributes associated with the one or more change information;
program instructions to, create, by the change summary illustrator, one or more change size magnitudes and one or more pervasiveness magnitudes, wherein the one or more change size attributes and the one or more pervasiveness attributes, are categorized and summarized, respectively;
program instructions to, create, by the change summary illustrator, one or more illustrative representations associated with the one or more associated component identifiers comprising the one or more change size magnitudes and the one or more pervasiveness magnitudes; and
program instructions to, output, by the change summary illustrator, the one or more illustrative representations associated with the software product change identifier.

16. The computer system of claim 15, wherein determine, by the change summary illustrator, the one or more change information is based on tagging at least one of the one or more change size attributes and the one or more pervasiveness attributes based on at least one of one or more predetermined change size attributes and one or more predetermined pervasiveness attributes, respectively.

17. The computer system of claim 15, wherein create, by the change summary illustrator, the one or more change size magnitudes is based on the one or more change size attributes matching one of a one or more predetermined threshold value range associated with predetermined one or more change size magnitude categories comprising identifiers of tiny, small, medium, large and extra-large.

18. The computer system of claim 15, wherein create, by the change summary illustrator, the one or more pervasiveness magnitudes is based on the one or more pervasiveness attributes matching one of a one or more predetermined threshold value range associated with predetermined one or more pervasiveness magnitude categories comprising identifiers of small, medium, large and customer unique.

19. The computer system of claim 15, wherein generate, by the change summary illustrator, the one or more illustrative representations further comprises at least one of one or more selectable component change size criteria and one or more selectable pervasiveness criteria.

20. The computer system of claim 15, wherein the one or more associated component identifiers is based on one or more change documentation sources wherein the one or more change documentation sources comprise at least one of a fix pack, a service pack, Authorized Program Analysis Report, patch notes, release notes and source code.
